(19) United States
(12) Patent Application Publication
(10) Pub. No.: US 2008/0228505 A1
(43) Pub. Date: Sep. 18, 2008

(54) Client Deployment Optimization Model

(76) Inventors: Kevin Hanes, Round Rock, TX (US); Steven Bodnar, Austin, TX (US); Stephen Oates, Georgetown, TX (US); Jefferson Raley, Austin, TX (US); Gregory Bomsta, Austin, TX (US)

Correspondence Address: HAMILTON & TERRILE, LLP, P.O. BOX 203518, AUSTIN, TX, 78720, US

(21) Appl. No.: 11/685,373

(22) Filed: Mar. 13, 2007

(51) Int. Cl. G06Q 10/00

(52) U.S. Cl. 705/1

(57) ABSTRACT

A deployment optimization model that identifiers and categorizes issues (such as key cost and quality drivers) in information handling system deployment and provisioning. The deployment optimization model is used within a deployment and evaluation tool which provides based on this model, a set of processes and tools for evaluating information handling system deployment issues of customers. Based on information derived from the deployment and evaluation tool, it is possible to determine a customer's current cost to deploy information handling systems as well as a future cost if various recommendations are adopted.

### CROSS REFERENCE TO RELATED APPLICATION

This application relates to co-pending U.S. patent application Ser. No. ______, attorney docket number DC-12039, filed on an even date herewith, entitled “Method for Information Handling System Deployment Assessment,” naming Kevin Hanes, Gregory Bomsta, Stephen Oates and Jefferson Raley as inventors, which is incorporated herein by reference in its entirety.

This application relates to co-pending U.S. patent application Ser. No. ______, attorney docket number DC-12042, filed on an even date herewith, entitled “Method to Determine Software Rationalization for Optimizing Information Handling System Deployments,” naming Jefferson Raley, Gregory Bomsta, Kevin Hanes, Stephen Oates and Kurt Stonecipher as inventors, which is incorporated herein by reference in its entirety.

This application relates to co-pending U.S. patent application Ser. No. ______, attorney docket number DC-12152, filed on an even date herewith, entitled “Optimized Deployment Solution,” naming Stephen Oates, Kevin Hanes, Marc Jarvis and Jefferson Raley as inventors, which is incorporated herein by reference in its entirety.

### BACKGROUND OF THE INVENTION

1. Field of the Invention

The present invention relates to providing information handling system services and more particularly to client deployment optimization models when providing information handling system services.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity). The large scale information handling system installation provides an information handling system environment.

One issue relating to the service and support of information handling system installation relates to providing an ability for predicting issues (e.g., determining a cost) associated with deploying a plurality of information handling systems. The costs associated with deploying information handling systems can be as much as or greater than the cost of the information handling system being deployed.

Known optimization models describe how customers can reduce costs by applying best practices but often do not deal specifically with information handling system deployment. Additionally, known optimization models are generated at a very high level. Thus, known optimization models often do not provide an approach that is tactical enough to provide a customer's information technology (IT) staff with detailed knowledge regarding steps involved in an information handling system deployment and the costs associated with each of the steps of the information handling system deployment.

It would be desirable to provide a structured approach to evaluating and determining costs associated with deploying a customer's information handling system costs

### SUMMARY OF THE INVENTION

In accordance with the present invention, a deployment optimization model is provided that identifies and categorizes issues (such as key cost and quality drivers) in information handling system deployment and provisioning. The deployment optimization model is used within a deployment and evaluation tool which provides based on this model, a set of processes and tools for evaluating information handling system deployment issues of customers. Based on information derived from the deployment and evaluation tool, it is possible to determine a customer's current cost to deploy information handling systems as well as a future cost if various recommendations are adopted.

More specifically, in one embodiment, the invention relates to a method for optimizing a deployment of information handling systems which includes storing a deployment optimization matrix within a memory, selecting points within the deployment optimization matrix, and generating an optimized deployment recommendation based upon the desired deployment.

The deployment optimization matrix comprising a plurality of rows and each of the plurality of rows comprises a plurality of columns. The plurality of rows corresponds to factors that evaluate and contribute to deployment of information handling systems. The plurality of columns corresponds to a sophistication level of each factor. Each of the points corresponds to a desired deployment level for a corresponding factor.

In another embodiment, the invention relates to an apparatus for optimizing a deployment of information handling systems which includes means for storing a deployment optimization matrix within a memory, means for selecting points within the deployment optimization matrix, each of the points corresponding to a desired deployment level for a corresponding factor, and means for generating an optimized deployment recommendation based upon the desired deployment. The deployment optimization matrix comprises a plurality of rows and each of the plurality of rows comprises a plurality of columns. The plurality of rows corresponds to factors that evaluate and contribute to deployment of information handling systems. The plurality of columns corresponds to a sophistication level of each factor.

In another embodiment, the invention relates to an information handling system which includes a processor, memory coupled to the processor, and a deployment optimization matrix. The memory comprises a module for optimizing a deployment of information handling systems which optimizes the deployment of information handling systems. The deployment optimization matrix comprises a plurality of rows and each of the plurality of rows comprise a plurality of columns. The plurality of rows corresponds to factors that evaluate and contribute to deployment of information handling systems. The plurality of columns corresponds to a sophistication level of each of factor. The deployment optimization matrix includes instructions for selecting points within the deployment optimization matrix, each of the points corresponding to a desired deployment level for a corresponding factor, and generating an optimized deployment recommendation based upon the desired deployment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system on which the deployment and evaluation tool is executed.

FIG. 2 shows a block diagram of a deployment and evaluation tool.

FIG. 3 shows a flow diagram of the operation of the deployment and evaluation tool.

FIG. 4 shows a block diagram of a deployment optimization model.

### DETAILED DESCRIPTION

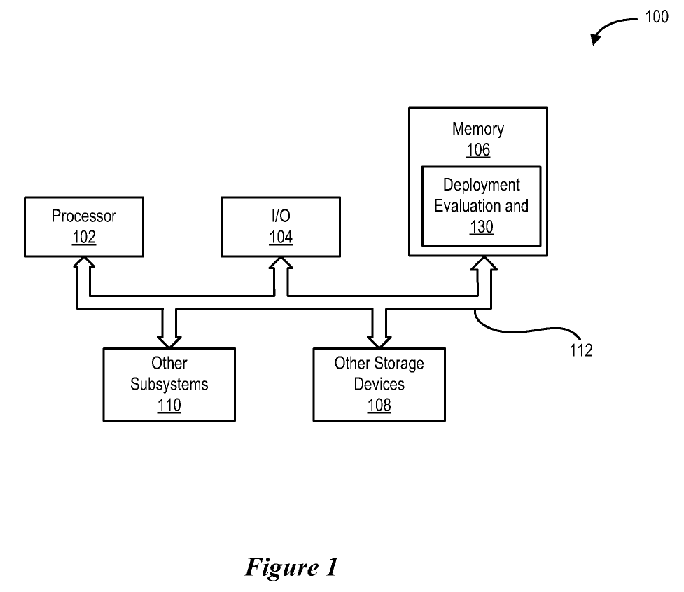

Referring to FIG. 1, a system block diagram of an information handling system 100 on which the deployment and evaluation tool is executed is shown. The information handling system 100 includes a processor 102, input/output (I/O) devices 104, such as a display, a keyboard, a mouse, and associated controllers, a memory 106 including non volatile memory such as a hard disk drive and volatile memory such as random access memory (RAM), and other storage devices 108, such as an optical disk and drive and other memory devices, and various other subsystems 110, all interconnected via one or more buses 112. A deployment and evaluation tool 130 is stored on the memory 106 and executed by the processor 102.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

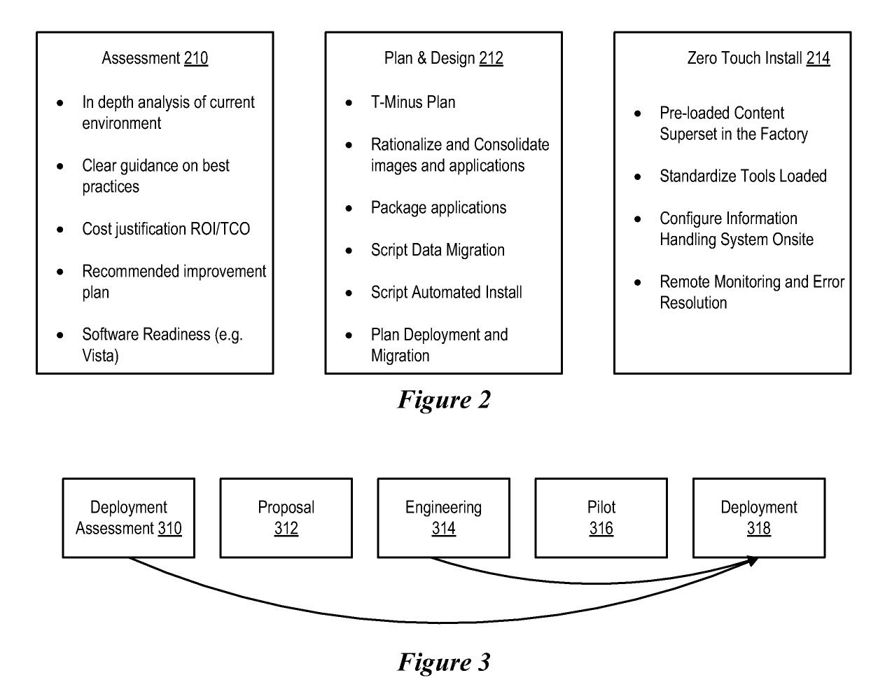

Referring to FIG. 2 a block diagram of the deployment and evaluation tool 130 is shown. More specifically, the deployment and evaluation tool 130 includes an assessment portion 210, a plan & design portion 212 and a highly efficient information handling system deployment process portion 214.

The assessment portion 210 provides an in depth analysis of a current customer information handling system environment. The assessment portion 210 also provides clear guidance to the customer regarding information handling system environment best practices. The assessment portion 210 also provides support for a deployment cost justification, both with respect to a deployment return on investment (ROI) and a total cost of ownership (TCO). The assessment portion 210 also provides a recommended improvement plan for a customer information handling system environment. The assessment portion 210 also determines a software readiness of a current customer information handling system environment. The software readiness can determine, for example, the readiness of a current customer information handling system environment to effectively execute a new operating system such as the Microsoft Vista Operating System.

The plan & design portion 212 develops a recommended readiness (T-Minus) plan. The plan & design portion 212 also rationalizes and consolidates images and applications for install onto information handling systems that are to be deployed. The plan & design portion 212 also packages applications for the information handling systems being deployed. The plan & design portion 212 also develops a script data migration for the information handling systems being deployed. The plan & design portion 212 also develops an automated script install for the information handling systems being deployed. The plan & design portion 212also develops a plan for the deployment and migration of the information handling system environment.

The highly efficient information handling system deployment process portion 214 generates a content superset for the content that is to be preloaded onto the information handling system and installs the content superset onto the information handling systems being deployed. The highly efficient information handling system deployment process portion 214 also develops and standardizes tools that are loaded onto the information handling system being deployed. The highly efficient information handling system deployment process portion 214 also enables onsite configuration of the deployed information handling systems. The highly efficient information handling system deployment process portion 214 also provides for remote monitoring and error resolution of deployed information handling systems.

Referring to FIG. 3, a flow diagram of the operation of the deployment tool 130 is shown. More specifically, the deployment and evaluation tool 130 begins operation by performing a deployment assessment at step 310. A proposal for an information handling system deployment environment is then developed at step 312. Once the proposal is accepted, engineering to develop the information handling system deployment environment is performed at step 314. Next, a pilot of the information handling system deployment environment is deployed at step 316. Next the information handling system deployment environment is deployed at step 318.

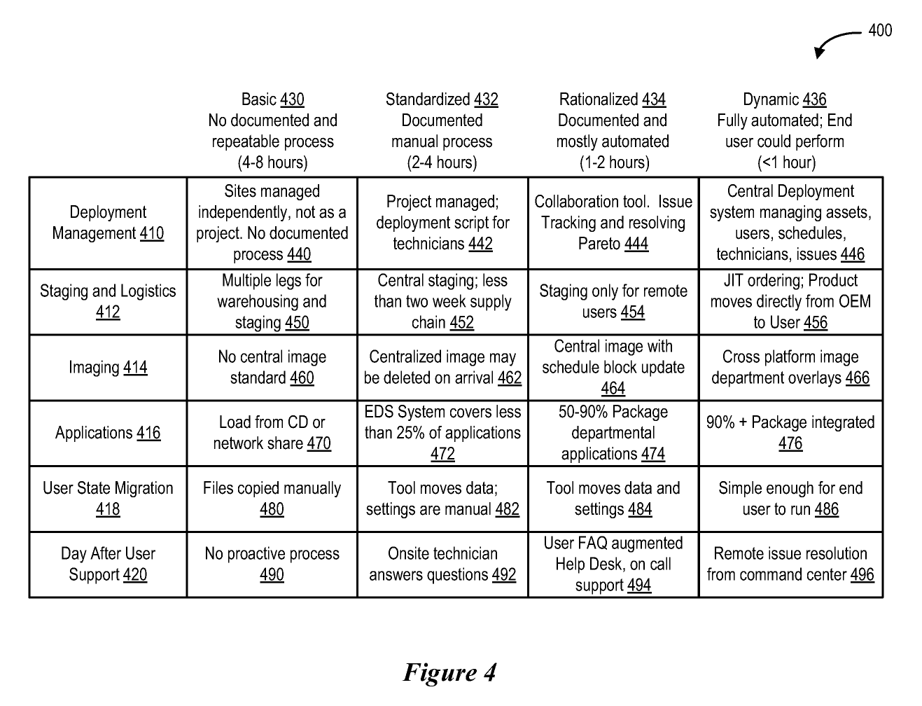

FIG. 4 shows a block diagram of a deployment optimization model 400. The deployment optimization model 400 allows automation and commoditization when deploying information handling systems. The deployment optimization model 400 also provides a cost justification as well as an accurate total cost of ownership projection.

The deployment optimization model is represented as a matrix in which the rows list major factors that evaluate best practices with information handling system deployment and the columns rate each factor in terms of sophistication. By selecting points within the matrix, it is possible to optimize and develop a deployment strategy that is optimized for a particular customer. The points within the matrix are set forth with a granularity that allows a deployment strategy to be developed that is predictable and thus allows cost associated with the deployment to be accurately estimated.

More specifically, the rows of the deployment optimization model matrix 400 correspond to major factors that evaluate best practices with information handling system deployment. These factors are specifically designed to be clear and easily understandable. More specifically, the factors that are considered by the deployment optimization model include deployment management 410, staging and logistics 412, imaging 414, applications 416, user state migration 418 and day after user support 420.

The columns of the deployment optimization model matrix 400 correspond to a sophistication level rating of each factor. The four levels include a basic level 430, a standardized level 432, a rationalized level 434 and a dynamic level 426. These levels correlate to the optimization levels in the infrastructure optimization model available from Microsoft Corporation. More specifically, the basic level represents manual processes with little to no standardization across groups within the organization. The standardized level represents standardized processes that are largely manual. The rationalized level represents a significant use of automation. The dynamic level represents fully automated and integrated processes with validation checks. By moving up the levels within the optimization model, more standardization and automation is present. Developing a set of highly integrated tools and processes that enable a low cost deployment that is nearly invisible to the end user. Different industries often have different levels of sophistication. For example, industries that are regulated and controlled often require a much higher level of sophistication than companies that are not mandated by government mandates.

The deployment management factor 410 indicates an extent to which an efficient deployment solution is possible. An efficient deployment is often possible when a large number of systems are installed at a single location and within the same timeframe. This enables the best utilization of technology and infrastructure. It also allows technicians to work on multiple systems at the same time. An efficient deployment solution utilizes a dedicated planning system that tracks site readiness, user readiness, system configuration, schedules, and deployment status. The deployment management factor 410 includes a deployment management basic level 440, a deployment management standardized level 442, a deployment management rationalized level 444, and a deployment management dynamic level 446.

With the deployment management basic level 440 sites are managed independently, not as a project. There is no documented process. With the deployment management standardized level 442, the project is managed and there is a deployment script available for technicians. With the deployment management rationalized level 444, a collaboration tool for issue tracking and resolving is used. With the deployment management dynamic level 446 a central deployment system for managing assets, users, schedules, technicians and issues is used.

The shipping and logistics factor 412 indicates an extent to which an efficient staging and logistics deployment is present. Adding shipping legs to move information handling systems to interim locations (such as staging centers or warehouse) adds cost, time, and complexity to the supply chain. In the early phases of deployment optimization, these costs are often offset by efficiencies gained through staging. A fully optimized process can achieve the same efficiencies without the added cost of multiple shipping legs. More specifically, the staging and logistics factor 412 includes a staging and logistics basic level 450, a staging and logistics standardized level 452, a staging and logistics rationalized level 454 and a staging and logistics dynamic level 456.

With the staging and logistics basic level 450 multiple legs are used for warehousing and staging of deployed information handling systems. With the staging and logistics standardized level 452, a central staging area is used. The central staging area generally holds information handling systems for less than a two week supply chain. With the staging and logistics rationalized level 454, a staging area is used only for remote users. With the staging and logistics dynamic level 456, just in time ordering is used so that the product moves directly from a supplier to the user.

The imaging factor 414 indicates an extent to which imaging is used to more efficiently deploy information handling systems. Regarding the imaging factor 414, developing and managing images can consume valuable IT resources that can be better used on more strategic projects. This is especially true when separate images need to be maintained for each hardware platform in the environment. A desirable practice is to use cross-platform imaging technology (such as X-Image available from Dell, Inc. or ImageBuilder available from Dell, Inc. which commercially known packages. It is also desirable to provide a regularly scheduled block update process for maintaining operating system (OS) patches and application updates. Providing regularly scheduled block update processes can reduce rework during an onsite deployment. The use of the cross-platform imaging technologies enable desk-side provisioning of information handling systems.

Patches are installed at the time of deployment across the network via a information handling system management tool such as Marimba, SMS, Altiris, Managesoft or others. While it is beneficial that the OS security patches are packaged for easier deployment and consistency with the existing PCs in the environment, the process can be further improved by incorporating the OS security patches into the image. OS patches are downloaded from an application server during new information handling system provisioning. This process is largely automated and does not consume much actual work time. It can, however, consume significant cycle time (e.g., 15 to 60 minutes) and network bandwidth that affects the end-user population.

The imaging factor 414 includes an imaging basic level 460, an imaging standardized level 462, an imaging rationalized level 464, and an imaging dynamic level 466. With the imaging basic level, there is no central image. With the imaging standardized level 462, a centralized image may be deleted upon deployment of the information handling system. With the imaging rationalized level 464, a centralized image is available which includes a schedule block update. With the imaging dynamic level 466, a cross platform image is available which includes department (or other sub-segment) overlays.

The applications factor 416 indicates an extent to which automated configuration is used to more efficiently deploy information handling systems. Regarding the applications factor 416, automated configuration management systems (such as SMS and Marimba which are industry known products) dramatically reduce the variable cost of deploying new information handling systems. Additionally, automated configuration management systems can increase the fixed cost of packaging applications for automated and unattended installation.

The application factor 416 includes an application basic level 470, an application standardized level 472, an application rationalized level 474, and an application dynamic level 476. With the application basic level 470, applications are loaded onto each deployed information handling system via disks, such as CD or DVD ROMs or via a network. With the application standardized level 472, an automated configuration management system is used for less than 50% of the applications being installed on the deployed information handling systems. With the application rationalized level 474, between 50 and 90% of departmental applications are packaged for automatic configuration. With the application dynamic level 476, 90% or more of the applications are integrated on the deployed information handling systems and application deployment is integrated with a software license entitlement system so that licensed applications are automatically installed and application deployment is integrated with a software license entitlement system so that licensed applications are automatically installed.

The user state migration factor 418 describes the process of identifying and transferring all user data and settings from an old information handling system to the newly deployed information handling system. This process enforces information technology standards and contains protections to ensure that user data is not lost. User state migration over the network can require enormous bandwidth. For example, a typical user will need to transfer 2-4 GB of data and settings. A desirable solution transfers data over a local cable (e.g., a crossover or USB 2 cable) and is integrated into the automated deployment process so that end users and technicians do not have to identify data and settings to be transferred.

The user state migration factor 418 includes a user state migration basic level 480, a user state migration standardized level 482, a user state migration rationalized level 484, and a user state migration dynamic level 486. With the user state migration basic level 480, files are copied manually from the old information handling system to the newly deployed information handling system. With the user state migration standardized level 482, a migration tool moves data, but settings are manually transferred from the old information handling system to the newly deployed information handling system. With the user state migration rationalized level 484, a migration tool moves data and settings from the old information handling system to the newly deployed information handling system. With the user state migration dynamic level 486, the transfer of data and settings from the old information handling system to the newly deployed information handling system is simple enough for the end user to complete.

With the day after user support factor 420, new information handling system deployments can result in an expensive spike in calls to an information technology provider service desk. Those calls often represent frustration and a loss of end-user productivity. Proactive planning can help to reduce this impact. Job aids and floor walks are commonly used to ease the transition. One practice is to combine job aids with remote control technology so that a centralized service desk can resolve issues without dispatching a technician to the user's desk.

The day after user support factor 420 includes a day after user support basic level 490, a day after user support standardized level 492, a day after user support rationalized level 494 and a day after user support dynamic level 496. With the day after user support basic level 490, no proactive day after user support is implemented. With day after user support standardized level 492, an onsite technician is provided for answering questions. With the day after user support rationalized level 494, a user frequently asked questions (FAQ) is provided along with an augmented help desk and on call support. With the day after user support dynamic level 496, remote issue resolution is provided via a user support command center.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the deployment optimization model could include additional levels. Also, the levels and factors of the deployment optimization model could be modified to correspond to a customer's specific environmental characteristics. Also, the deployment optimization model could include additional factors.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or DVDs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for optimizing a deployment of information handling systems comprising
storing a deployment optimization matrix within a memory, the deployment optimization matrix comprising a plurality of rows and each of the plurality of rows comprising a plurality of columns, the plurality of rows corresponding to factors that evaluate and contribute to deployment of information handling systems, the plurality of columns corresponding to a sophistication level of each of factor;
selecting points within the deployment optimization matrix, each of the points corresponding to a desired deployment level for a corresponding factor; and,
generating an optimized deployment recommendation based upon the desired deployment.

2. The method of claim 1, wherein
the factors include at least one of a deployment management factor, a staging and logistics factor, an imaging factor, an applications factor, a user state migration factor and a day after user support factor.

3. The method of claim 2, wherein
the deployment management factor indicates an extent to which an efficient deployment solution is possible.

4. The method of claim 2, wherein
the staging and logistics factor indicates an extent to which an efficient staging and logistics deployment is present.

5. The method of claim 2, wherein
the imaging factor indicates an extent to which imaging is used to more efficiently deploy information handling systems.

6. The method of claim 2, wherein
the applications factor indicates an extent to which automated configuration is used to more efficiently deploy information handling systems.

7. The method of claim 2, wherein
the user state migration factor indicates an extent to which state migration is used to more efficiently deploy information handling systems.

8. The method of claim 2, wherein
the day after user support factor indicates an extent to which day after user support is used to more efficiently deploy information handling systems.

9. The method of claim 1, wherein:
the levels include at least one of a basic level, a standardized level, a rationalized level and a dynamic level.

10. An apparatus for optimizing a deployment of information handling systems comprising
means for storing a deployment optimization matrix within a memory, the deployment optimization matrix comprising a plurality of rows and each of the plurality of rows comprising a plurality of columns, the plurality of rows corresponding to factors that evaluate and contribute to deployment of information handling systems, the plurality of columns corresponding to a sophistication level of each of factor;
means for selecting points within the deployment optimization matrix, each of the points corresponding to a desired deployment level for a corresponding factor; and,
means for generating an optimized deployment recommendation based upon the desired deployment.

11. The apparatus of claim 10, wherein
the factors include at least one of a deployment management factor, a staging and logistics factor, an imaging factor, an applications factor, a user state migration factor and a day after user support factor.

12. The apparatus of claim 11, wherein
the deployment management factor indicates an extent to which an efficient deployment solution is possible.

13. The apparatus of claim 11, wherein
the staging and logistics factor indicates an extent to which an efficient staging and logistics deployment is present.

14. The apparatus of claim 11, wherein
the imaging factor indicates an extent to which imaging is used to more efficiently deploy information handling systems.

15. The apparatus of claim 11, wherein
the applications factor indicates an extent to which automated configuration is used to more efficiently deploy information handling systems.

16. The apparatus of claim 11, wherein
the user state migration factor indicates an extent to which state migration is used to more efficiently deploy information handling systems.

17. The apparatus of claim 11, wherein
the day after user support factor indicates an extent to which day after user support is used to more efficiently deploy information handling systems.

18. The apparatus of claim 10, wherein:
the levels include at least one of a basic level, a standardized level, a rationalized level and a dynamic level.

19. An information handling system comprising
a processor;
memory coupled to the processor, the memory comprising a module for optimizing a deployment of information handling systems, the module for optimizing the deployment of information handling systems comprising
a deployment optimization matrix, the deployment optimization matrix comprising a plurality of rows and each of the plurality of rows comprising a plurality of columns, the plurality of rows corresponding to factors that evaluate and contribute to deployment of information handling systems, the plurality of columns corresponding to a sophistication level of each of factor, and,
instructions for:
selecting points within the deployment optimization matrix, each of the points corresponding to a desired deployment level for a corresponding factor; and,
generating an optimized deployment recommendation based upon the desired deployment.

20. The information handling system of claim 19, wherein
the factors include at least one of a deployment management factor, a staging and logistics factor, an imaging factor, an applications factor, a user state migration factor and a day after user support factor.

21. The information handling system of claim 20, wherein
the deployment management factor indicates an extent to which an efficient deployment solution is possible.

22. The information handing system of claim 20, wherein
the staging and logistics factor indicates an extent to which an efficient staging and logistics deployment is present.

23. The information handling system of claim 20, wherein
the imaging factor indicates an extent to which imaging is used to more efficiently deploy information handling systems.

24. The information handling system of claim 20, wherein
the applications factor indicates an extent to which automated configuration is used to more efficiently deploy information handling systems.

25. The information handling system of claim 20, wherein
the user state migration factor indicates an extent to which state migration is used to more efficiently deploy information handling systems.

26. The information handling system of claim 20, wherein
the day after user support factor indicates an extent to which day after user support is used to more efficiently deploy information handling systems.

27. The information handling system of claim 19, wherein:
the levels include at least one of a basic level, a standardized level, a rationalized level and a dynamic level.
